(19) United States
(12) Patent Application Publication
(10) Pub. No.: US 2014/0037917 A1
(43) Pub. Date: Feb. 6, 2014

(54) PRINTED LAMINATE WITH DIGITAL PRINTING AND METHOD FOR MANUFACTURE

(71) Applicant: Wilsonart LLC, Temple, TX (US)

(72) Inventors: Joe E. Branch, China Spring, TX (US); Eric W. Kendall, Temple, TX (US); Robert R. Krebs, Georgetown, TX (US); John P. McSpedon, Temple, TX (US); Janet Stepan, Temple, TX (US); Joel L. Williams, Temple, TX (US)

(73) Assignee: Wilsonart LLC, Temple, TX (US)

(21) Appl. No.: 13/954,199

(22) Filed: Jul. 30, 2013

Related U.S. Application Data
(60) Provisional application No. 61/677,737, filed on Jul. 31, 2012.

(51) Int. Cl. B41M 7/00; B05D 7/00

(52) U.S. Cl. CPC B41M 7/0045; B05D 7/57
USPC 428/205; 427/258

(57) ABSTRACT

A printed laminate includes a substrate and a priming layer positioned over the substrate, wherein digital printing is applied to the priming layer. A top coat layer is applied over the digital printing and the priming layer, the top coat layer being composed of a clear hot melt polyurethane first top coat layer and a clear UV cured acrylic second top coat layer.

### CROSS REFERENCE TO RELATED APPLICATION

This application claims the benefit of U.S. Provisional Patent Application Ser. No. 61/677,737, entitled “PRINTED LAMINATE WITH DIGITAL PRINTING AND METHOD FOR MANUFACTURE,” filed Jul. 31, 2012.

### BACKGROUND OF THE INVENTION

1. Field of the Invention

The present invention relates to decorative laminates. More particularly, the present invention relates to digitally printed decorative laminates.

2. Description of the Related Art

Traditional coating systems used in conjunction with digital printing equipment include UV cured white priming layers applied to a substrate to provide opacity and a surface upon which to print. Once the priming layers of a substrate are printed upon, the primed and printed substrates are then top coated with clear UV cured protective coatings.

### SUMMARY OF THE INVENTION

It is, therefore, an object of the present invention to provide a printed laminate including a substrate and a priming layer positioned over the substrate, wherein digital printing is applied to the priming layer. A top coat layer is applied over the digital printing and the priming layer, the top coat layer being composed of a clear hot melt polyurethane first top coat layer and a clear UV cured acrylic second top coat layer.

It is also an object of the present invention to provide a printed laminate wherein the substrate is medium density fiberboard.

It is another object of the present invention to provide a printed laminate wherein the substrate is a phenolic core backer laminate.

It is a further object of the present invention to provide a printed laminate wherein the substrate is high pressure decorative laminate.

It is also an object of the present invention to provide a printed laminate wherein the substrate is treated with an adhesion promoter.

It is another object of the present invention to provide a printed laminate wherein a filler layer is positioned between the substrate and the priming layer.

It is a further object of the present invention to provide a printed laminate wherein the priming layer is a white UV cured acrylic.

It is also an object of the present invention to provide a printed laminate wherein the coat weight of the white UV cured acrylic of the priming layer is between a proximately 18 grams/meter² and approximately 100 grams/meter².

It is another object of the present invention to provide a printed laminate wherein the coat weight of the clear hot melt polyurethane first top coat layer is approximately 40 grams/meter² to approximately 80 grams meter².

It is a further object of the present invention to provide a printed laminate wherein the coat weight of the clear UV cured acrylic second top coat layer is approximately 5 gams/meter to approximately 20 grams/meter².

It is also an object of the present invention to provide a method for manufacturing a printed laminate comprising applying a priming layer to a substrate, digitally printing upon the priming layer, applying a clear hot melt polyurethane first top coat layer to the priming layer with digital printing thereon, and applying a clear UV cured acrylic second top coat layer to the clear hot melt polyurethane top coat layer.

Other objects and advantages of the present invention will become apparent from the following detailed description when viewed in conjunction with the accompanying drawings, which set forth certain embodiments of the invention.

### BRIEF DESCRIPTION OF THE DRAWINGS

FIGS. 1 to 4 are schematics showing the steps in manufacturing the present printed laminate, wherein FIG. 4 shows the final printed laminate prior to optional embossing in accordance with the present invention.

FIGS. 5 and 6 are schematics showing the steps in applying embossing to the digitally printed laminate shown in FIG. 4, wherein FIG. 6 shows the final printed and embossed laminate in accordance with the present invention.

FIG. 7 is a schematic showing a printed laminate in accordance with the present invention using a phenolic core hacker laminate substrate.

FIG. 8 is a schematic showing a printed laminate in accordance with the present invention using a rejected high pressure decorative laminate substrate.

FIG. 9 is a flow chart showing a preferred manufacturing process for printed laminates in accordance with the present invention.

### DESCRIPTION OF THE PREFERRED EMBODIMENTS

The detailed embodiments of the present invention are disclosed herein. It should be understood, however, that the disclosed embodiments are merely exemplary of the invention, which may be embodied in various forms. Therefore, the details disclosed herein are not to be interpreted as limiting, but merely as a basis for teaching one skilled in the art how to make and/or use the invention.

Referring to the various embodiments disclosed herein, the present invention generally relates to digitally printed decorative laminates (i.e., printed laminates) 100 and a method for the manufacture of digitally printed decorative laminates 100. In particular, the present invention relies upon a combination of coatings used to prepare substrates that are digitally printed. The coatings disclosed herein provide for unique performance characteristics.

In its broadest sense, the present invention includes a priming layer composed of a white UV cured coating layer applied to the substrate so as to create a primed substrate. The primed substrate is then printed upon using digital printing techniques. A top coat layer is then applied to the primed and printed substrate, wherein the top coat layer includes a clear hot melt polyurethane layer followed by a clear UV cured acrylic coating layer.

The present invention offers various advantages, in particular, the present invention includes fewer processing steps than prior UV coating systems, offers lower costs than prior hot melt polyurethane systems and provides improved impact resistance over all other UV systems. In addition, the present invention offers the ability to emboss the laminate without cracking the surface thereof. It is appreciated the present coating system may be utilized in conjunction with substrates such as medium density fiberboard, high pressure laminate, phenolic core backer laminate sheets and pressed board.

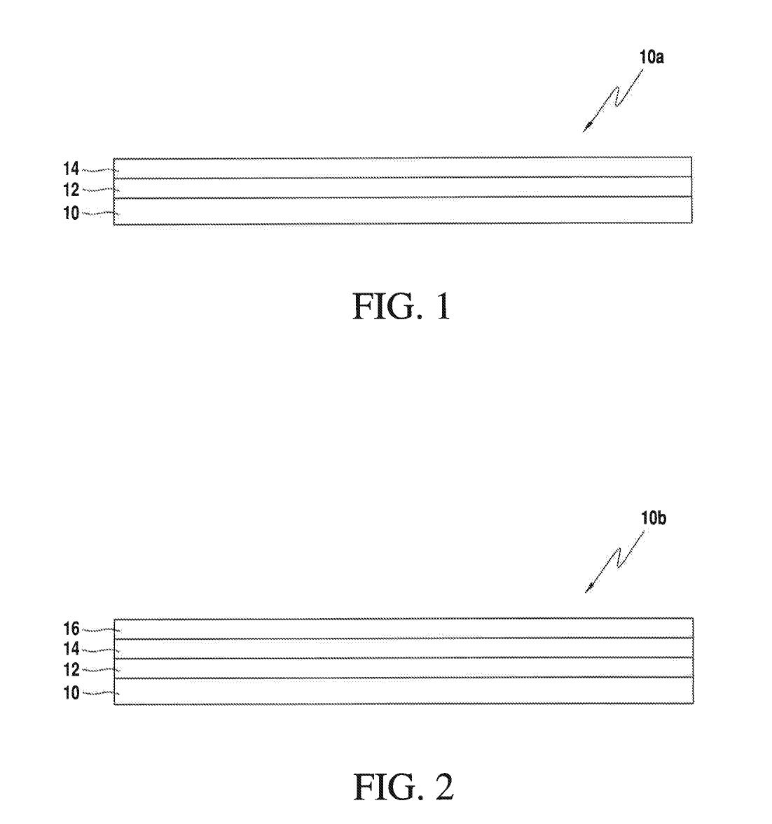

It should first be appreciated similar reference numerals are used for the various embodiments disclosed herein, where the components referenced thereby are similar. With reference to the embodiment disclosed with reference to FIGS. 1 to 4, the manufacture of a decorative laminate 100 is disclosed. A substrate 10 of medium density fiberboard is first pre-treated with the application of a UV cured adhesion promoter layer 12. In accordance with a preferred embodiment, the adhesion promoter is Waterborne UV Clear (Klumpp 178-000-02093), manufactured by Klumpp Coatings of Germany. The adhesion promoter is preferably applied with a coat weight of approximately 5 grams/meter² to approximately 10 grams/meter². Thereafter, a filler layer 14 is applied over the adhesion promoter layer 12. The filler is applied in multiple layers to a coat weight as needed to fill pores and surface imperfections, preferably approximately 10 grams/meter² to approximately 60 grams/meter². In accordance with a preferred embodiment, the filler is UV Clear with Filler (Klumpp 168-000-0211), manufactured by Friedrich Klumpp GmbH of Germany.

Once the substrate 10 is pre-treated with the adhesion promoter layer and the filler layer, the priming layer 16 is applied. In accordance with a preferred embodiment, the priming layer 16 is composed of a white UV cured acrylic and it is applied to a coat weight necessary to fully cover the pre-treated substrate 10a. A preferred material is UV White Pigmented (Klumpp 161-900-02090), manufactured by Friedrich Klumpp GmbH of Germany. As the pre-treated substrate 10a will exhibit different surface characteristics, the coat weight of the UV cured acrylic that must be applied to achieve a desired surface for printing will vary. It is, therefore, appreciated the coat weight of the UV cured acrylic priming layer 16 is preferably between approximately 18 grams/meter² and approximately 100 grams/meter². It is further appreciated other priming coating materials may be used in accordance with the present invention, for example, priming coatings composed of water-based latex paints, plastic white fillers, paper layers, and ceramic layers. Hot melt polyurethanes may also be used in the formation of the priming layer, and it is appreciated the use of hot melt polyurethanes would result in a shortening of the production line. However, hot melt polyurethanes are currently very expensive when compared to UV cured acrylics.

The primed substrate 10b is then ready for digitally printing 18. In accordance with a preferred embodiment, the primed substrate 10b is printed digitally using machinery and ink manufactured by Durst Phototechnik Digital Technology GmbH.

Once the substrate is primed and printed, the top coat layer 20 is applied thereto. The top coat layer 20 in accordance with a preferred embodiment of the present invention includes a first top coat layer 22 of clear hot melt polyurethane and a second top coat layer 24 of clear UV cured acrylic. The coat weight of the clear hot melt polyurethane first top coat layer 22 determines various functional characteristics of the final product and these characteristics are ultimately balanced in determining the coat weight of the clear hot melt polyurethane first top coat layer 22 applied to the primed and printed substrate 10c. In particular, increased coat weight will result in improved impact resistance and an increased resistance to abrasion. However, increased coat weight increases the cost of production. In accordance with a preferred embodiment, the clear hot melt polyurethane is applied with a coat weight of approximately 40 grams/meter² to approximately 80 grams/meter². It is further appreciated the coat weight of the clear hot melt polyurethane should not be less than 40 grams/meter². In accordance with a preferred embodiment, the hot melt polyurethane is PUR Hot Coat Clear (no aluminum oxide) manufactured by Klebchemie M.G. Becker GmbH+Co. of Germany under the manufacturer number Kleiberit 717.1. It is also appreciated, the hot melt polyurethane may contain aluminum oxide to enhance wear and scratch resistance.

Thereafter, a clear UV cured acrylic second top coat layer 24 is applied to the clear hot melt polyurethane first top coat layer 22. In accordance with a preferred embodiment, the UV cured acrylic is applied with a total coat weight of approximately 5 grams/meter² to approximately 20 grams/meter². The clear UV cured acrylic is preferably UV Clear Acrylic (no aluminum oxide) manufactured by Kleiberit of Germany under the manufacturer number 817.1. The resulting product is fully cured and the decorative laminate 100 is ready for use.

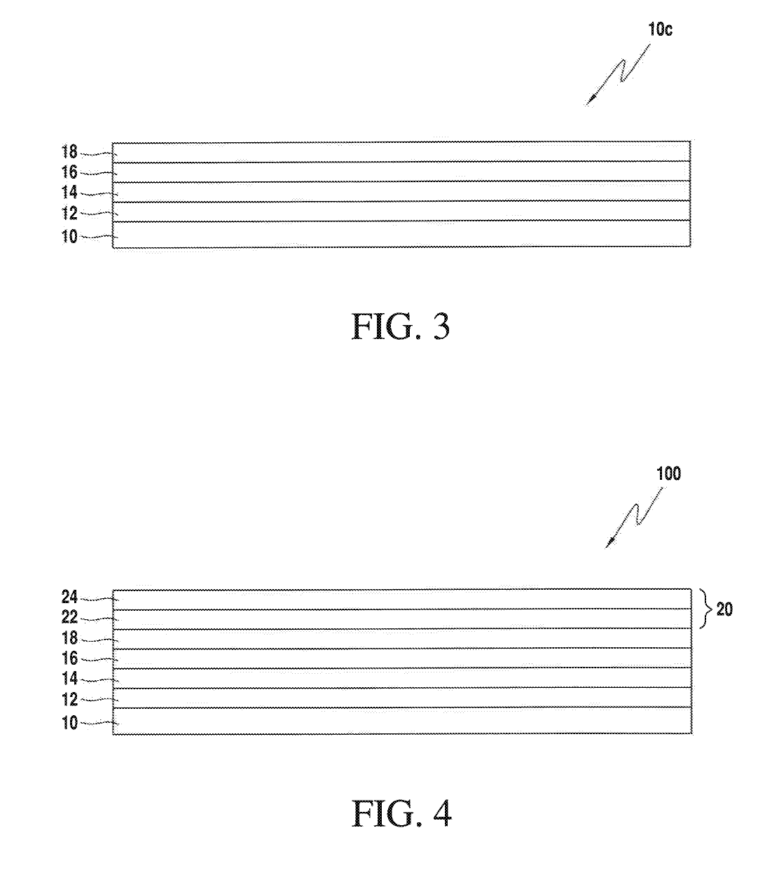

The foregoing describes a basic digitally printed substrate in accordance with the present invention. However, and with reference to FIGS. 5 and 6, it is appreciated that the utilization of a clear hot melt polyurethane first top coat layer 22 allows for embossing of patterns into the resulting decorative laminate 100. In accordance with a preferred embodiment, a Sharklet® (that is, polymer film, namely, for use in preventing bacteria and other microorganisms from adhering to surfaces) pattern embossing film or metal stamp 30 is applied to the decorative laminate 100 prior to complete curing of the clear hot melt polyurethane first top coat layer 22. This allows for embossing of features at an approximate depth of 6 micrometers.

More particular, the pre-embossed decorative laminate 100 shown in FIG. 5 is manufactured as described above with reference to FIGS. 1 to 4. That is, the substrate 10 is first pre-treated with an adhesion promoter layer 12 and a filler layer 14. Once the pretreatment of the substrate 10 is completed, the priming layer 16 is applied. The primed substrate 10b is then digitally printed and the top coat layer 20 composed a first top coat layer 22 of clear hot melt polyurethane and a second top coat layer 24 of clear UV cured acrylic is applied thereto.

Once the layering of the decorative laminate 100 is complete, but prior to complete curing of the clear hot melt polyurethane first top coat layer 22 (appreciating the fact that the hot melt polyurethane will fully cure in 3 days), the upper surface 32 of the decorative laminate 100, in particular, the exposed surface 34 of the UV cured acrylic second top coat layer 24 is contacted with a stamp 30 imparting a desired texture to the top coat layer 20. This results from the fluidity of the clear hot melt polyurethane prior to fully curing and the protection offered by the UV cured acrylic coating.

As briefly discussed above the concepts underlying the present invention may be applied to a phenolic core backer laminate substrate. It is appreciated that a phenolic core backer laminate is a plurality of sheets of phenolic impregnated Kraft paper consolidated under heat and pressure to form a single unitary phenolic core backer laminate. Such structures are commonly used in the manufacture of high pressure decorative laminates.

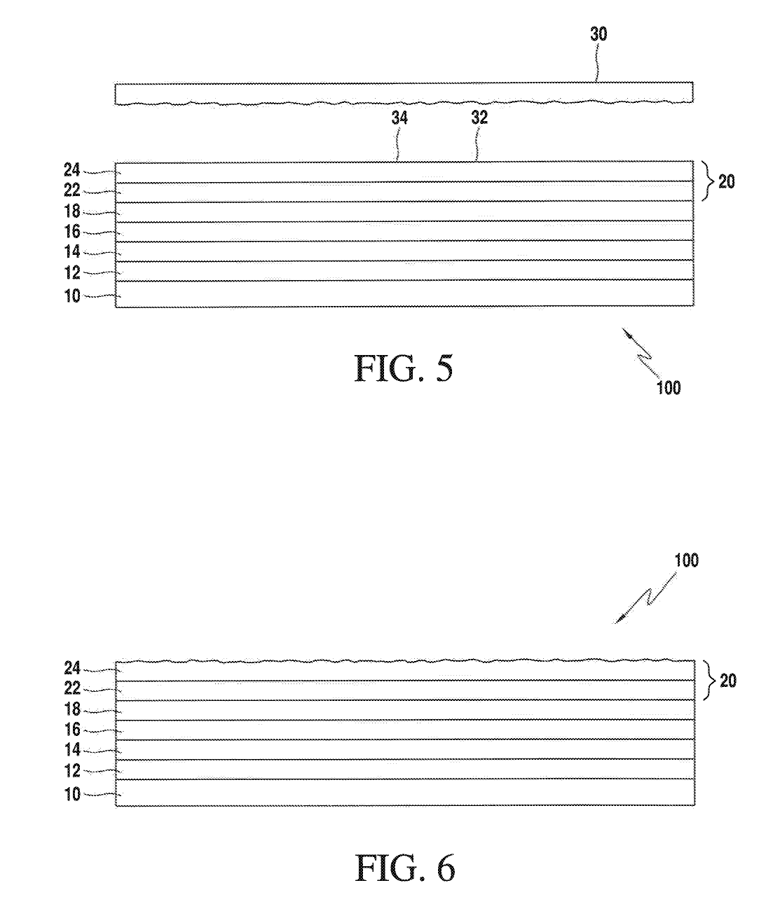

In accordance with such an embodiment, and with reference to FIG. 7, a decorative laminate 100 is manufactured in the following manner. The phenolic core hacker laminate substrate 10 is first pre-treated with an adhesion promoter layer 12 and a filler layer 14. Once the pretreatment of the substrate 10 is completed, the priming layer 16 is applied. The primed phenolic core backer laminate substrate 10b is then digitally printed 18 and the top coat layer 20 composed a first top coat layer 22 of clear hot melt polyurethane and a second top coat layer 24 of clear UV cured acrylic is applied thereto. With the exception of the substrate and the application of the filler layer, these steps are the same as disclosed above with regard to FIGS. 1 to 4.

As those skilled in the art will appreciate, the foregoing methodology for the production of a decorative laminate from a phenolic core backer laminate is new. Typically, the surface of a decorative laminate is produced using decorative papers and overlays treated with melamine resin. The decorative paper/overlay produces the surface appearance and the melamine resin produces these surface quality values. The methodology described above eliminates the need for decorative paper and melamine resin. These items are replaced with a digitally printed solid color or image which is top coated with a UV cured resin system to give the surface characteristics necessary. With the present invention, the digital printing is applied directly onto the phenolic core backer laminate that has been consolidated under heat and pressure to form the phenolic core backer laminate without the use of a high pressure press. The digital printed surface produces similar surface properties achieved on a laminate.

This concept eliminates the need for expensive decorative papers, eliminates the need for expensive overlay papers, eliminates the need for melamine resin, produces superior visual quality images, allows faster service for customized print orders (made print-on-demand for customers with any image they would like to use), and allows for the printing of print solid colors/images onto a phenolic core backer laminate.

in accordance with yet a further element of the present invention, the concepts underlying the present invention may be utilized in the digital printing of rejected high pressure decorative laminate. In particular, and as is appreciated by those skilled in the art, the surface of a high pressure decorative laminate is produced using decorative papers and overlays treated with melamine resin. These materials are fused together in a high pressure press to produce the laminate. The decorative paper produces the surface appearance and the overlay/melamine resin produces the surface quality values. On a daily basis, sheets of laminate are rejected due to visual defects on the surface. These defects are caused by dirt particles, contamination and/or other surface defects that make the laminate unacceptable to use. The present embodiment allows for the digital printing of solid colors/patterns or different types of images onto the surface of rejected laminate sheets.

In accordance with the reuse of defective high pressure decorative laminate, the surface thereof is renewed using the concepts underlying the present invention and the defective high pressure decorative laminate becomes a new product.

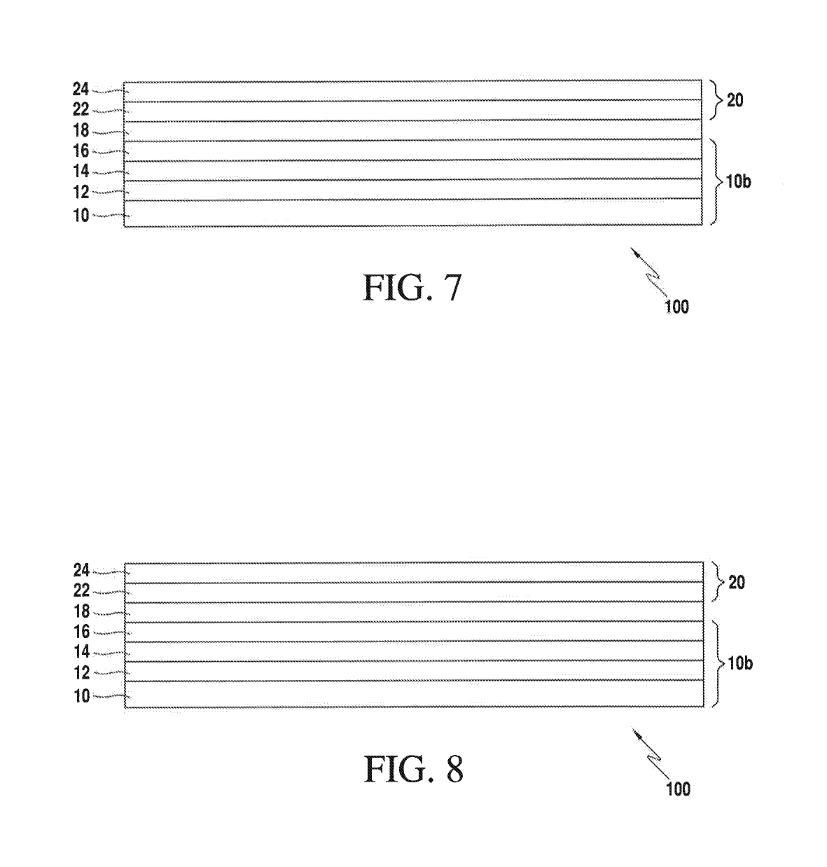

In particular, and with reference to FIG. 8, the manufacture of a decorative laminate 100 using defective high pressure decorative laminate is disclosed, A substrate 10 of rejected high pressure decorative laminate is first sanded to remove surface texture, some melamine resin, and then is pre-treated with an adhesion promoter layer 12 and a tiller layer 14. Once the pretreatment of the substrate 10 is completed, the priming layer 16 is applied. The primed high pressure decorative laminate substrate 10b is then digitally printed 18 and the top coat layer 20 composed a first top coat layer 22 of clear hot melt polyurethane and a second top coat layer 24 of clear UV cured acrylic is applied thereto. With the exception of the substrate, these steps are the same as disclosed above with regard to FIGS. 1 to 4.

This embodiment allows for the renewed use of the surface of a rejected high pressure decorative laminate sheet by turning it into a premium product, allows for the recovery of costs from loss sales of rejected laminate sheets, allows for a great reduction in waste, produces superior visual quality images, permits on demand printing for customers with any image they would like to use and allows for the use of printed solid colors/patterns/images onto rejected laminate material. Ultimately, the present invention creates a new product which allows one to digitally print solid colors or decorative images onto a rejected sheet of laminate. The invention allows one to salvage and use rejected sheets of laminate to produce a premium grade product.

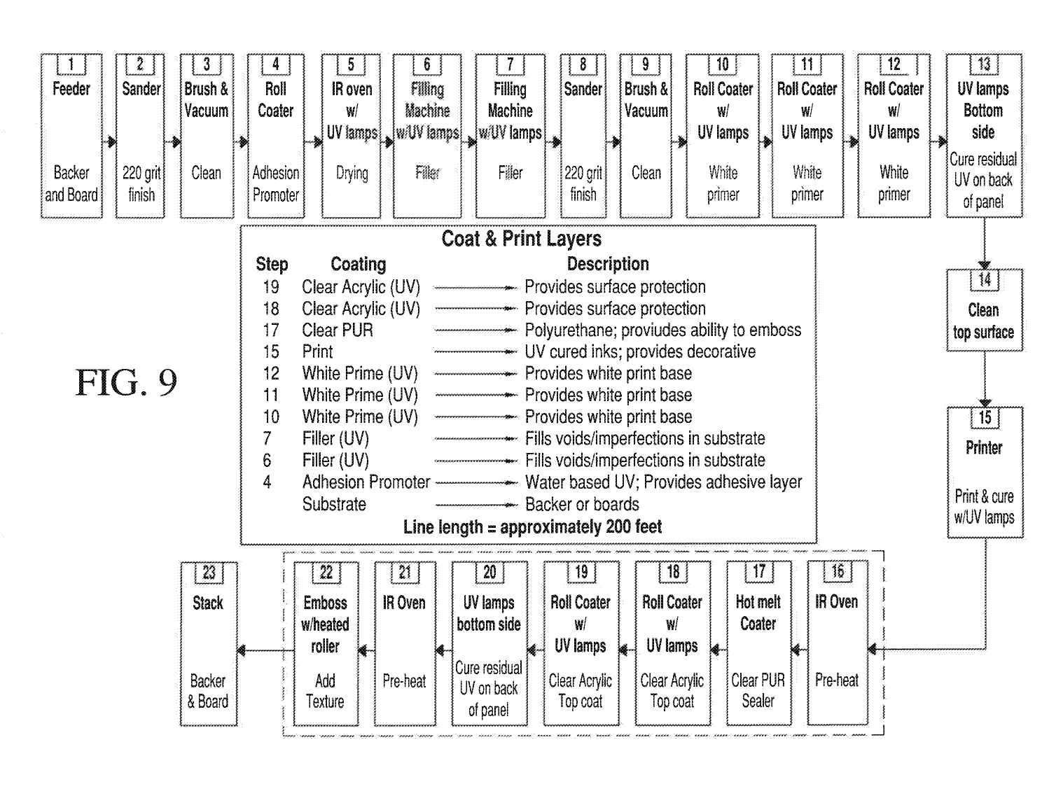

A preferred processing procedure for the manufacture of decorative laminate 100 in accordance with the present invention is shown with reference to FIG. 9. Unless otherwise noted, the disclosed processing steps apply to the fabrication of decorative laminate whether the substrate is medium density fiberboard, particleboard, phenolic core backer laminate or rejected high pressure decorative laminate. It is also appreciated manufacturing parameters are disclosed below based upon current knowledge, and it is possible these parameters may vary depending upon source materials, equipment, etc. The substrate 10 is first fed into the line using a conventional automated feed system. Where the substrate 10 is a phenolic core backer laminate or a rejected high pressure decorative laminate, it is sanded using a series of different grit sandpaper to prepare the surface of the substrate 10 for coating and printing. During the sanding process, a combination of 80 grit, 100 grit, 120 grit, 180 grit and 220 grit and other grades of sandpaper are utilized to achieve smoothness necessary for printing visual quality.

Thereafter, the substrate 10 is cleaned using a brush and vacuum. Once the substrate is fully cleaned, the upper surface 40 thereof is treated with an adhesion promoter utilizing a roil coater to form the adhesion promoter layer 12. The substrate 10 is then passed through an infrared (IR) oven followed by UV lamps for the purpose of drying the UV cured adhesion promoter. The adhesion promoter layer 12 and the substrate 10 are subjected to the oven for approximately 10 seconds to approximately 100 seconds, and preferably 30 seconds at approximately 25 degrees Celsius to approximately 75 degrees Celsius with the application approximately 550 mJ/cm² to approximately 650 mJ/cm² irradiation so as to complete B stage cure of the UV cured adhesion promoter.

The substrate 10 is treated with a filler and simultaneously subjected to UV curing through the utilization of UV lamps so as to form the filler layer 14 upon the adhesion promoter layer 12. This is completed utilizing a two stage procedure. In accordance with the first stage, pores and imperfections are filled with the filler and subjected to an irradiation of approximately 300 mJ/cm² to approximately 450 mJ/cm² irradiation to complete the B stage curing of the UV cured filler. The second stage again fills pores and imperfections and is subjected to irradiation of approximately 650 mJ/cm² to approximately 800 mJ/cm² irradiation for a complete cure. It is appreciated the first stage application of filler may not be necessary with medium density fiberboard. It is appreciated that B stage curing indicates curing to the point that slight deformation will occur if the surface is scratched with a coin and full curing indicates curing to the point that no deformation will occur if the surface is scratched with a coin.

The UV cured filler layer 14 is then sanded (this may be unnecessary with phenolic core backer laminate or a rejected high pressure decorative laminate). It is noted that the full cure in the second stage is necessary so as to permit the sanding of the filler layer 14. Sanding is completed utilizing a series of sandpaper with grit sizes ranging from 80 to 220 grit and the substrate 10, with the adhesion promoter layer 12 and filler layer 14 applied thereto, is once again cleaned using a brush and vacuum station. Thereafter, the UV cured acrylic priming layer 16 is applied in a three step process. The three step process consecutively applies three layers utilizing UV lamps to cure the UV cured acrylic primer as the process proceeds. The first stage utilizes approximately 350 mJ/cm² to approximately 450 mJ/cm² irradiation to achieve a B stage cure of the first coating of the UV cured acrylic primer. Similarly, the second stage utilizes approximately 350 mJ/cm² to approximately 450 mJ/cm² irradiation to achieve a B stage cure of the second coating of the UV cured acrylic primer. The final UV cured acrylic primer coating is subjected to approximately 750 mJ/cm² to approximately 850 mJ/cm² irradiation to achieve a full cure of the UV cured priming layer 16. It is appreciated that the amount of energy required for partial or complete cure depends on the coat weight of the priming layer 16.

Thereafter, the substrate 10 is subjected to a back side cure at approximately 750 mJ/cm² to approximately 850 mJ/cm² irradiation so as to cure any residual UV cured material that may have accumulated on the back side of the substrate 10. The substrate 10 is then cleaned prior to printing utilizing a Wandress brush cleaning system with de-ionizing solution.

The substrate is then ready for printing and printing is achieved using an industrial ink jet printer. The ink jet printer includes a vacuum belt so as to hold down the thin laminates. Once printing is completed, the substrate 10 is preheated using an infrared (IR) oven and the hot melt polyurethane first top coat layer 22 is applied. The hot melt polyurethane is applied utilizing a Barberan Hot Melt Coater. Finally, the UV cured acrylic second top coat layer 24 is applied in a two step process where the UV cured acrylic is applied in a first coat which is B stage cured with the application approximately 200 mJ/cm² to approximately 500 mJ/cm². Thereafter, a second coat of UV cured acrylic is applied and fully cured utilizing approximately 1000 mJ/cm² to approximately 1200 mJ/cm² irradiation to achieve a full cure. The back side is then once again cured utilizing UV radiation so as to achieve a full cure by the application of approximately 750 mJ/cm² to approximately 850 mJ/cm² irradiation.

Where it is desired to apply embossing, the coated substrate is passed through an IR oven for pre-heating and the upper surface, that is, the second top coat layer 24 is subjected to a roller embossing system utilizing a heated roller. Thereafter, an automatic stacker retrieves the decorative laminate 100 from the line and the decorative laminate 100 is ready for distribution.

While the preferred embodiments have been shown and described, it will be understood that there is no intent to limit the invention by such, disclosure, but rather, is intended to cover all modifications and alternate constructions falling within the spirit and scope of the invention.

1. A printed laminate, comprising:
a substrate;
a priming layer positioned over the substrate, wherein digital printing is applied to the priming layer; and
a top coat layer applied over the digital printing and the priming layer, the top coat layer being composed of a clear hot melt polyurethane first top coat layer and a clear UV cured acrylic second top coat layer.

2. The printed laminate according to claim 1, wherein the substrate is medium density fiberboard.

3. The printed laminate according to claim 1, wherein the substrate is a phenolic core backer laminate.

4. The printed laminate according to claim 1, wherein the substrate is high pressure decorative laminate.

5. The printed laminate according to claim 1, wherein the substrate is treated with an adhesion promoter.

6. The printed laminate according to claim 5, wherein a filler layer is positioned between the substrate and the priming layer.

7. The printed laminate according to claim 1, wherein the priming layer is a white UV cured acrylic.

8. The printed laminate according to claim 7, wherein the coat weight of the white UV cured acrylic of the priming layer is between approximately 18 grams/meter² and approximately 100 grains/meter².

9. The printed laminate according to claim 1, wherein the coat weight of the clear hot melt polyurethane first top coat layer is approximately 40 grams/meter² to approximately 80 grams/meter².

10. The printed laminate according to claim 1, wherein the coat weight of the clear UV cured acrylic second top coat layer is approximately 5 grams/meter² to approximately 20 grams/meter.

11. A method for manufacturing a printed laminate, comprising:
applying a priming layer to a substrate;
digitally printing upon the priming layer;
applying a clear hot melt polyurethane first top coat layer to the priming layer with digital printing thereon; and
applying a clear UV cured acrylic second top coat layer to the clear hot melt polyurethane top coat layer.

12. The method according to claim 11, wherein the substrate is medium density fiberboard.

13. The method according to claim 11, wherein the substrate is a phenolic core backer laminate.

14. The method according to claim 11, wherein the substrate is high pressure decorative laminate.

15. The method according to claim 11, further including the step of treating the substrate with an adhesion promoter.

16. The method according to claim 15, further including the step of applying a filler layer is to the substrate after the step of treating.

17. The method according to claim 11, wherein the priming layer is a white UV cured acrylic.

18. The method according to claim 17, wherein a coat weight of the white UV cured acrylic of the priming layer is between approximately 18 grams/meter² and approximately 100 grams/meter².

19. The method according to claim 11, wherein a coat weight of the clear hot melt polyurethane first top coat layer is approximately 40 grams/meter² to approximately 80 grams/meter².

20. The method according to claim 11, wherein a coat weight of the clear UV cured acrylic second top coat layer is approximately 5 grams/meter² to approximately 20 grams/meter².
